(19) United States
(12) Patent Application Publication
(10) Pub. No.: US 2012/0047467 A1
(43) Pub. Date: Feb. 23, 2012

(54) PORT COMPATIBILTY CHECKING FOR STREAM PROCESSING

(75) Inventors: Michael D. Pfeifer, Rochester, MN (US); Jingdong Sun, Rochester, MN (US)

(73) Assignee: International Business Machines Corporation, Armonk, NY (US)

(21) Appl. No.: 12/857,790

(22) Filed: Aug. 17, 2010

(51) Int. Cl. G06F 17/30; G06F 3/048

(52) U.S. Cl. 715/853; 707/758; 707/E17.005

(57) ABSTRACT

A port compatibility connection engine for a large scale stream processing framework is provided. The port compatibility management unit analyzes port definitions of processing elements (PEs) to validate interconnectivity between said elements. In particular, the port compatibility management unit determines the ability of the PEs to produce and/or consume data streams based on the data stream schema definitions specified on the PE ports. In addition, the port compatibility management unit analyzes security, scope, persistence, and other factors that impact interconnectivity. The port compatibility management unit generates a connection topology snapshot based on the above analysis and identifies the combination of PEs that cannot interconnect and provides the information in an output format that allows for visualization, filtering, and automatic fix capability.

### STATEMENT REGARDING FEDERALLY SPONSORED RESEARCH OR DEVELOPMENT

This invention was made with Government support under Contract No. H98230-07-C-0383 awarded by the Department of Defense. The Government has certain rights in this invention.

### BACKGROUND

1. Technical Field

The field of invention relates to large scale stream processing. In particular, the field of invention relates to port compatibility checking in large scale stream processing systems.

2. Description of the Related Art

As the amount of data available to enterprises and other organizations has dramatically grown, it has become increasingly difficult for companies to analyze and extract business decisions in real-time.

Today, large scale stream processing frameworks enable efficient extraction of information from enormous volumes and varieties of continuous data streams, so end users can analyze many streams of multi-modal information in real-time, to answer inquiries and help make better business decisions.

A challenge with the large scale system processing frameworks is the inability to diagnose why stream mining applications running on these processing frameworks fail to properly process data streams. In particular, processing elements in stream mining applications that compute data streams in real time and output processed data streams to other processing elements may be unable to route data streams between ports of different processing elements for unspecified reasons. Thus, what is needed is an improved system for managing and diagnosing port compatibility issues between said processing elements.

### SUMMARY OF THE DISCLOSURE

The disclosure and claims herein are directed to a port compatibility management unit for a large scale stream processing framework.

In one embodiment, a method for port compatibility checking in a data stream processing systems is provided. The method begins by analyzing each processing element pair combination in a stream processing application for connection compatibility. The method then creates a topology snapshot of the stream mining application based on the analysis. Next, the topology snapshot is stored in a topology snapshot repository residing on the data stream processing system. Then, connection compatibility issues identified by the analysis are automatically fixed by an automated fix engine, whenever possible. Finally, the topology snapshot of the stream mining application is updated based on the fixing.

In an embodiment, the method further includes the steps of identifying any unresolved connection compatibility issues that remain within the topology snapshot; interactively reviewing connection compatibility issues identified within the topology snapshot for possible fixes and interactively repairing connection compatibility issues identified by the review, whenever possible.

In an embodiment, the method step of interactively reviewing connection compatibility issues identified within the topology snapshot for possible fixes further includes the step of displaying connection compatibility issues to a user via a data visualization interface.

In yet another embodiment, the present invention provides an apparatus for port compatibility checking in a data stream processing system. The apparatus includes a connection checking engine (CCE) for analyzing every processing element pair combination in a stream processing application for connection compatibility. The apparatus further includes a topology snapshot repository (TSR) communicatively coupled to the connection checking engine for storing a topology snapshot generated by the connection checking engine. The apparatus also includes a data visualization interface (DVI) communicatively coupled to the topology snapshot repository for displaying connection compatibility information. The apparatus also includes an automated fix engine communicatively coupled to the topology snapshot repository and the data visualization interface for repairing connection compatibility issues identified by the connection checking engine.

In one embodiment, the connection checking engine (CCE) further includes a CCE repository for keeping port compatibility checking policies, configuration settings, and an original connection mode. The CCE further includes a connection checking component for checking connections based on port compatibility checking policies and configuration settings stored in the CCE repository. In one embodiment, the apparatus further includes a self-learning engine embedded within the automated fix engine.

In another embodiment, the present invention provides a computer program product for port compatibility checking in data stream processing systems. The computer program product is disposed in a computer readable storage medium. The computer program product includes computer program instructions capable of: analyzing each processing element pair combination in a stream processing application for connection compatibility; creating a topology snapshot of the stream mining application based on the analysis; storing the topology snapshot in a topology snapshot repository residing on the data stream processing system; automatically fixing connection compatibility issues identified by the analysis via an automated fix engine, whenever possible; and updating the topology snapshot of the stream mining application based on the fixing.

The foregoing and other features and advantages will be apparent from the following more particular description, as illustrated in the accompanying drawings.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a graphical representation of interconnected processing elements (PEs) in a stream mining application.

FIG. 2 illustrates a block diagram of a port compatibility management unit.

FIG. 3 illustrates an example of two PE pair combinations within a data stream processing application, wherein each port within the each PE pair includes a data stream schema definition specifying the compatible types of data stream input and the structure of data stream output.

FIG. 4 is a flowchart illustrating a method for port compatibility checking in data stream processing systems in accordance with the present invention.

### DETAILED DESCRIPTION OF THE PREFERRED EMBODIMENTS

A port compatibility connection engine for a large scale stream processing framework is described herein. The port compatibility management unit analyzes port definitions of processing elements (PEs) to validate interconnectivity between said elements. In particular, the port compatibility management unit determines the ability of the PEs to produce and/or consume data streams based on the data stream schema definitions specified on the PE ports. In addition, the port compatibility management unit analyzes security, scope, persistence, and other factors that impact interconnectivity. The port compatibility management unit generates a connection topology snapshot based on the above analysis and identifies the combination of PEs that cannot interconnect and provides the information in an output format that allows for visualization, filtering, and automatic fix capability.

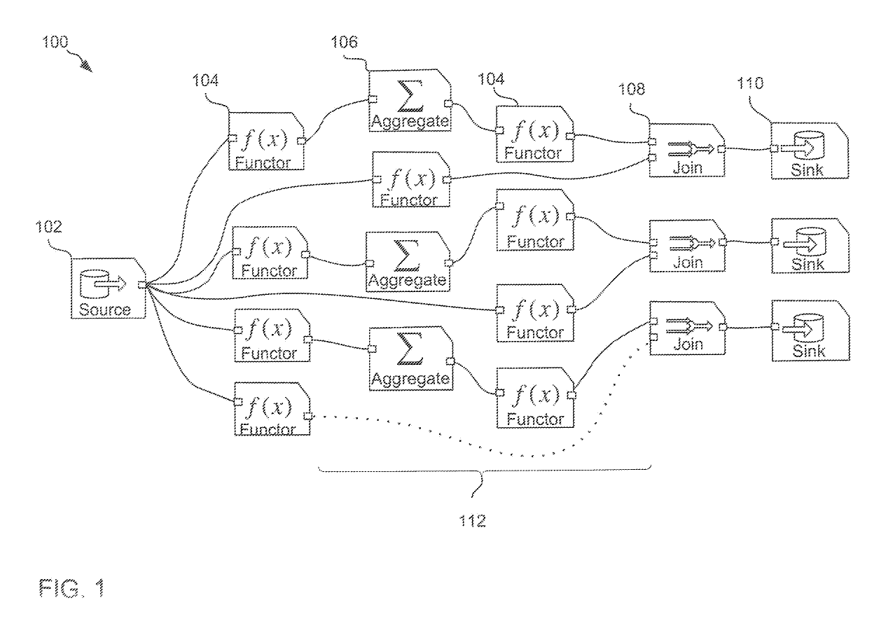

FIG. 1 illustrates a graphical representation of interconnected PEs in a stream mining application 100. As shown in FIG. 1, a data stream source 102 feeds multiple PE instances 104-110. These multiple PE instances include, but not limited to: PE functor 104 instances, PE aggregate 106 instances, PE join 108 instances and PE sink 110 instances. PE functor 104 instances apply at least one mathematical function to the data stream input, and produce a function modified data stream output. PE aggregate 106 instances perform a summation operation on a data stream input, and output a summed data stream. PE join 108 instances join a plurality of data streams into a single data stream output. PE sink 110 instances provide at least one data stream output from the stream mining application. The PE instance types 102-110 provided above are for illustrative purposes only, and it is contemplated that other PE instance types may be employed and still remain within the spirit and scope of the present invention.

A failed connection between two PEs result in an ambiguous gap 112, as illustrated by the dotted line, with no explanation of why a connection failed or possible remedies.

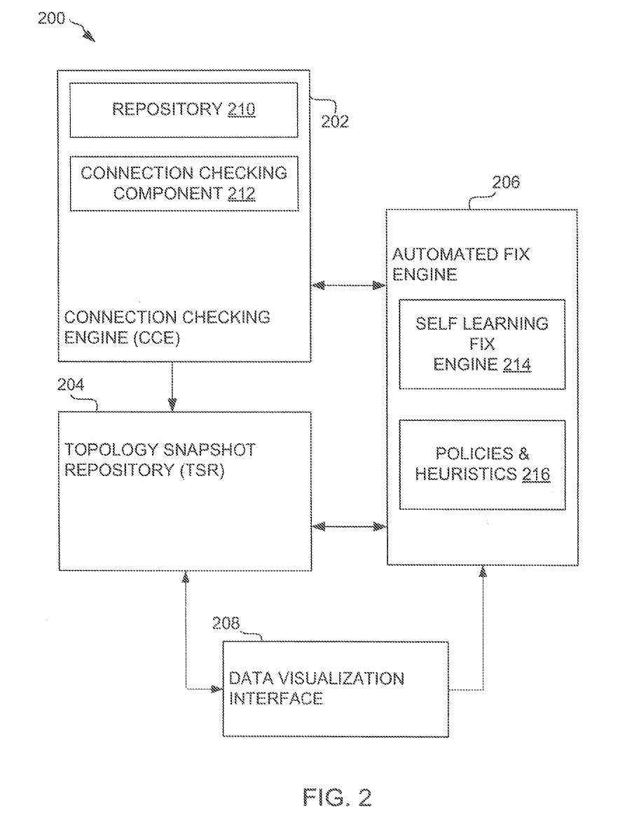

FIG. 2 illustrates a block diagram of a port compatibility management unit 200. The port compatibility management unit 200 includes a connection checking engine 202, a topology snapshot repository 204, an automated fix engine 206, and a data visualization interface 208.

Connection checking engine (CCE) 202 analyzes every PE pair combination on a stream mining application for connection compatibility. In particular, CCE 202 analyzes the PE port of each PE pair. Each PE port maintains a data stream schema definition that specifies the compatible types of data stream input and the structure of data stream output. Based on the data stream schema definition, CCE 202 validates connection compatibility between each port pair, wherein each port is analyzed as consumer and producer of a data stream. In addition CCE 202 determines compatibility between PE pairs based on security, scope, and persistence as examples. Other criteria for determining compatibility between PE pairs may also be employed and still remain within the spirit and scope of the present invention. CCE 202 creates a topology snapshot based on the analysis and outputs the results to a topology snapshot repository (TSR) 204.

In one embodiment, CCE 202 comprises: 1) a repository 210 to keep port compatibility check policies, configuration settings, and an original connection model; and 2) a connection checking component 212, which checks the connections within the connection model stored in repository 210, based on the compatibility check policies and configuration settings also stored in the repository.

CCE 202 analysis can be performed at application bring up and also at application runtime. During application bring up, a connection failure may be diagnosed by a number of factors, including but not limited to: schema data type mismatches, application scope mismatches, operators or PE's not running, and/or authority mismatches.

At runtime, connection failures may occur for a number for factors, including, but not limited to: security policies which have changes at runtime (e.g., a change in SELLinux security policies), a network failure, network congestion, a data stream monitor service problem (e.g., the CCE 202 itself) and operators or PE's down because of some error (e.g., data triggered PE down, PE application error (memory issues, etc.).

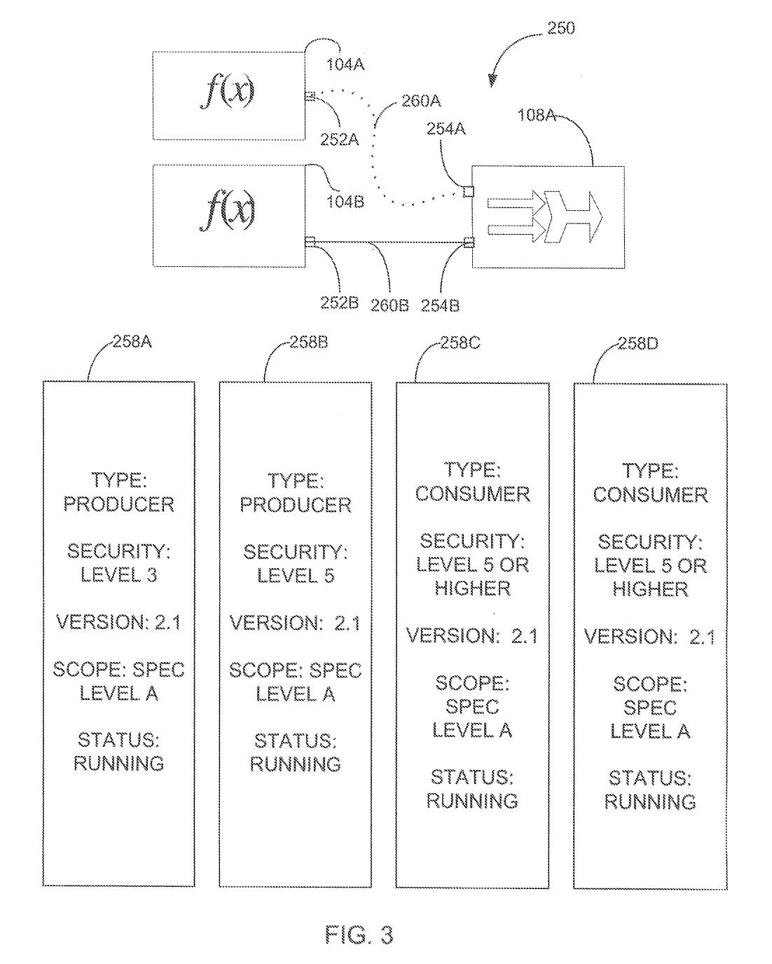

FIG. 3 illustrates an example of two PE pair combinations within a data stream processing application, wherein each port within the each PE pair includes a data stream schema definition specifying the compatible types of data stream input and the data stream output, shown generally at 250.

In the example two PE functor instances, 104A and 104B, have output ports 252A and 252B which supply input ports 254A and 254B of join instance 108A. Each of the output ports 252A and 252B have an associated data stream schema definition 258A and 258B, respectively, which include a set of attributes for each port. Similarly, input ports 254A and 254B also have associated data stream schema definitions 258C and 258D, which provides a set of attributes for each port.

In the illustrative example, associated data stream schema definitions 258A-258D include a number of attributes which are used to detect port compatibility issues in the data stream application. For example, one of the attributes is port type. One of the checks that CCE 202 might provide a port type compatibility check. Assuming a policy exists within the CCE 202 which states that each PE instance pair must have one producer port and one consumer port, both port pairs in the illustrative example (252A-254A and 252B-254B) pass this check.

Another type of potential attribute within the data stream schema definitions 258A-258D is version number. Assuming a policy exists within the CCE 202 which states that each PE instance pair must have the same version number, both port pairs in the illustrative example (252A-254A and 252B-254B) pass this check.

Yet another type of potential attribute within the data stream schema definitions 258A-258D is scope level. For example, scope level attributes might vary from A (very general), B (somewhat general), C (somewhat specific), and D (very specific). Assuming a policy exists within the CCE 202 which states that each PE instance pair must have the same scope level, both port pairs in the illustrative example (252A-254A and 252B-254B) pass this check.

Another type of potential attribute within the data stream schema definitions 258A-258D is status. For example, each port within each PE pair carries with it an attribute which indicates whether the associated PE instance is running or not running, and assuming a policy exists within the CCE 202 which states that each PE instance pair must be running in order for a valid connection, both port pairs in the illustrative example (252A-254A and 252B-254B) pass this check.

Finally, another type of potential attribute within the data stream schema definitions 258A-258D is security level. For example, each port within each PE pair carries with it a security level attribute which indicates whether the associated PE instance is authorized to produce/consume data from its associated counterpart port. Assuming a policy exists within the CCE 202 which states that consumer ports may only validly connect to counterpart producer ports which meet a predefined security level, in the illustrated example the 252B-254B port pair passes the security level check, while the 252A-254B port pair fails the security level check. As a result, the connection 260B between functor instance 104B and join instance 108A (i.e., the 252B-254B port pair) is indicated as solid, while the connection 260A between functor instance 104A and join instance 108A (i.e., the 252A-254A port pair) is shown as dotted, which indicates an invalid port connection.

Referring back to FIG. 2, TSR 204 stores the topology snapshot generated by the CCE 202 in a tree structure that identifies all compatible PE connections and streams. In particular, in one embodiment, the topology snapshot repository 204 maintains a tree edges object with connection information indicating ‘fail’ or ‘success’ for all the ports and streams. In the case of failures, the connection information includes the one or more causes of failure. In addition, the tree edges object stores connection information about the PE input and output ports. Each tree vertex (i.e., PE) defines tree edge objects that connect to other tree edge objects. TSR 204 includes an application programmer's interface (API) for accessing connection information.

Automated fix engine 206 employs a predefined set of policies and heuristics 216 in addition to a self learning fix engine 214 in order to fix connection compatibility issues identified by the CCE 202. Self learning fix engine 214 includes a modifiable database of user provided fixes (not shown) that are obtained when a user interactively resolves connection compatibility issues that could not be resolved by the predefined set of policies and heuristics 216. Once automated fix engine 206 employs fixes which affect the connections and streams of the current model, an updated topology snapshot of the stream processing application is written to the topology snapshot repository (TSR) 204 based on the fixes.

The data visualization interface 208 retrieves connection information via the topology snapshot repository 204 API. In one embodiment, the connection information is output in XML format. Using the retrieved connection information, the data visualization interface 208 displays a visual topology of the connection information for each PE combination selected by a user. In particular, the data visualization interface 208 may be configured to filter connection information to limit the display to user selected PE combinations, wherein the display includes valid and failed connections as well as the cause of the failure between PEs. For example, a user can select, via the data visualization interface 208, two PEs and have the data visualization interface 208 return all the reasons why no valid connection exists. Alternatively, a user can select to see all connections for the entire system that have compatible schemas, but are invalid because of a security incompatibility, for example.

The data visualization interface 208 is further configured to receive fix requests for invalid connections. The data visualization interface 208 relays the request to the automatic fix engine 206, wherein the automatic fix engine 208 is configured to resolve invalid connections using one or more predefined solutions made available via policies and heuristics 216 and the self learning fix engine 214.

If, for example, the data visualization interface 208 presents an invalid connection to the user, citing a version difference between two PE's, there may be a policy defined within the policies and heuristics 216 of the automated fix engine 206 to directly and automatically resolve the issue. If no such policy exists, a user might decide that the version difference between the two PEs will result in no compatibility issues, and may indicate that this connection is acceptable. The user may also be queried as to whether this invalid connection override is a “one time” override, or whether this override should be made on all instances of similar invalid connections in the future (i.e., become the general policy). If the user chooses this override to become a general policy, the self learning fix engine 214 will create a general fix policy which will be applied to all future instances of this incompatibility type.

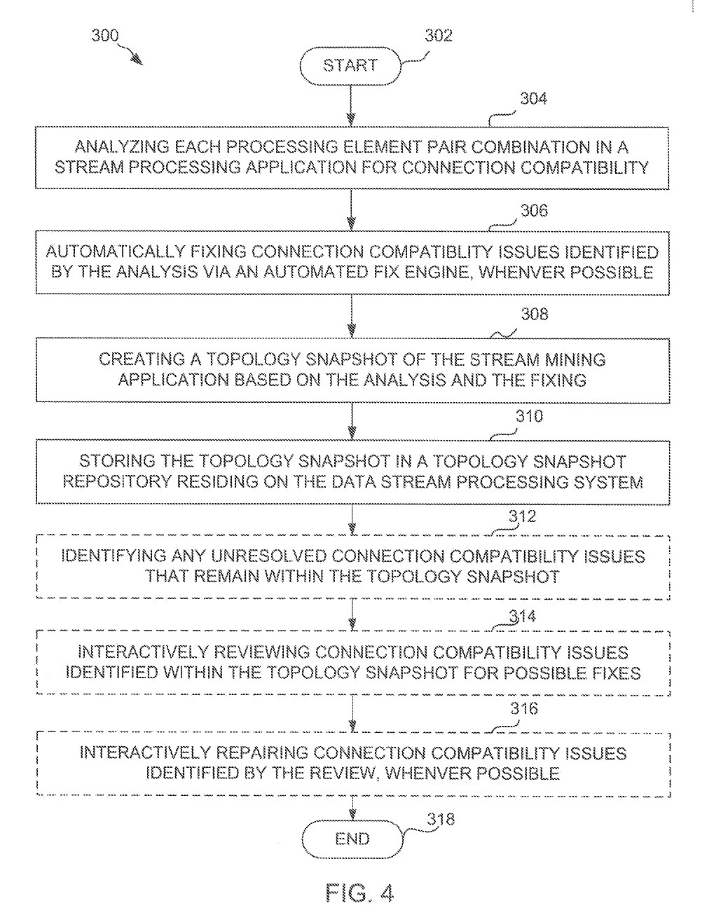

FIG. 4 is a flowchart illustrating a method for port compatibility checking in data stream processing systems 300, according to one embodiment of the invention.

As shown, the method begins at block 302. At block 304, the method analyzes each processing element pair combination in a stream processing application for connection compatibility. At block 306, the method automatically fixes connection compatibility issues identified by the analysis via an automated fix engine, whenever possible. At block 308, a topology snapshot of the stream mining application is created based on the analysis and the fixing. At block 310, the topology snapshot is stored in a topology snapshot repository residing on the data stream processing system.

In one embodiment, the method may also optionally include the additional steps of: 1) identifying any unresolved connection compatibility issues that remain within the topology snapshot (see block 312); 2) interactively reviewing connection compatibility issues identified within the topology snapshot for possible fixes (see block 314); and 3) interactively repairing connection compatibility issues identified by the review, whenever possible (see block 316). The method ends at block 318.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium(s) having computer readable program code embodied thereon.

The computer readable medium may be a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable storage medium may be transmitted using any appropriate medium, including but not limited to wireline, optical fiber cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

What is claimed is:

1. A method for port compatibility checking in data stream processing systems, the method comprising:
analyzing each processing element pair combination in a stream processing application for connection compatibility;
creating a topology snapshot of the stream mining application based on the analysis;
storing the topology snapshot in a topology snapshot repository residing on the data stream processing system;
automatically fixing connection compatibility issues identified by the analysis via an automated fix engine, whenever possible; and
updating the topology snapshot of the stream mining application based on the fixing.

2. The method of claim 1, wherein the method further comprises the step of:
identifying any unresolved connection compatibility issues that remain within the topology snapshot;
interactively reviewing connection compatibility issues identified within the topology snapshot for possible fixes; and
interactively repairing connection compatibility issues identified by the review, whenever possible.

3. The method of claim 2, wherein the method step of interactively reviewing connection compatibility issues identified within the topology snapshot for possible fixes further comprises the step of:
displaying connection compatibility issues to a user via a data visualization interface.

4. The method of claim 1, wherein the method is performed on the stream processing application prior to runtime of the stream processing application.

5. The method of claim 4, wherein the step of analyzing each processing element pair combination in a stream processing application for connection compatibility prior to runtime of the stream processing application includes performing at least one of the following checks between each element in the element pair combination: schema data type matching, application scope matching, version level matching, security level matching, and operators or PE's not running.

6. The method of claim 1, wherein the method is performed on the stream processing application at runtime of the stream processing application.

7. The method of claim 6, wherein the step of analyzing each processing element pair combination in a stream processing application for connection compatibility at runtime includes performing at least one of the following checks: checking security policies changed at runtime, checking network status, checking data stream monitor service, and checking operators or PE's not running.

8. A computer program product for port compatibility checking in data stream processing systems, the computer program product disposed in a computer readable storage medium, the computer program product comprising computer program instructions capable of:
analyzing each processing element pair combination in a stream processing application for connection compatibility;
creating a topology snapshot of the stream mining application based on the analysis;
storing the topology snapshot in a topology snapshot repository residing on the data stream processing system;
automatically fixing connection compatibility issues identified by the analysis via an automated fix engine, whenever possible; and
updating the topology snapshot of the stream mining application based on the fixing.

9. The computer program product of claim 8, further comprising computer program instructions capable of:
identifying any unresolved connection compatibility issues that remain within the topology snapshot;
interactively reviewing connection compatibility issues identified within the topology snapshot for possible fixes; and
interactively repairing connection compatibility issues identified by the review, whenever possible.

10. The computer program product of claim 8, wherein the computer program instructions capable of interactively reviewing connection compatibility issues identified within the topology snapshot for possible fixes further comprises:
displaying connection compatibility issues to a user via a data visualization interface.

11. The computer program product of claim 8, wherein the instructions are performed on the stream processing application prior to runtime of the stream processing application.

12. The computer program product of claim 11, wherein the step of analyzing each processing element pair combination in a stream processing application for connection compatibility prior to runtime of the stream processing application includes performing at least one of the following checks between each element in the element pair combination: schema data type matching, application scope matching, version level matching, security level matching, and operators or PE's not running.

13. The computer program product of claim 8, wherein the instruction are performed on the stream processing application at runtime of the stream processing application.

14. The computer program product of claim 13, wherein the step of analyzing each processing element pair combination in a steam processing application for connection compatibility at runtime include performing at least one of the following checks between each element in the element pair combination: checking security policies changed at runtime, checking network status, checking data stream monitor service, and checking operators or PE's not running.

15. An apparatus for port compatibility checking in a data stream processing system, comprising:
a connection checking engine (CCE) for analyzing every processing element pair combination in a stream processing application for connection compatibility;
a topology snapshot repository (TSR) communicatively coupled to the connection checking engine for storing a topology snapshot generated by the connection checking engine;
a data visualization interface (DVI) communicatively coupled to the topology snapshot repository for displaying connection compatibility information; and
an automated fix engine communicatively coupled to the TSR and the DVI for repairing connection compatibility issues identified by the CCE.

16. The apparatus of claim 15, wherein the connection checking engine further comprises:
a CCE repository for keeping port compatibility checking policies, configuration settings and an original connection model; and
a connection checking component which checks connection pairs within the original connection model based on port compatibility checking policies and configuration settings stored in the CCE repository; and

17. The apparatus of claim 15, wherein the topology snapshot is a true edges object with connection information indicating success or failure for all ports and streams within the stream processing application.

18. The apparatus of claim 15, wherein the automated fix engine includes a self-learning engine.
